(19) United States
(12) Patent Application Publication
(10) Pub. No.: US 2026/0343267 A1
(43) Pub. Date: Oct. 29, 2026

(54) QOE FOR RRC-IDLE MODE

(71) Applicant: NOKIA TECHNOLOGIES OY, Espoo (FI)

(72) Inventors: Guillaume DECARREAU, Munich (DE); Jing HE, Beijing (CN); Hakon HELMERS, Sceaux (FR); Malgorzata TOMALA, Wroclaw (PL)

(21) Appl. No.: 19/101,652

(22) PCT Filed: Aug. 8, 2022
(86) PCT No.: PCT/CN2022/110961

§ 371 Date: Feb. 6, 2025

(51) Int. Cl. H04W 24/08

(52) U.S. Cl. CPC H04W 24/08

(57) ABSTRACT

Embodiments of the present disclosure relate to handling of QoE sessions that survive RRC-IDLE mode. An access network device determine that a terminal device is to perform a quality of experience, QoE, measurement collection after disconnection from the first access network device; based on determining that the terminal device is to perform a QoE measurement collection after disconnection, transmit, to the terminal device, a QoE context identifier identifying QoE context information used for the QoE measurement collection; and transmit the QoE context identifier and the QoE context information to a core network device. As provided in the present disclosure, the stored QoE reports can be sent to the new serving gNB and then to MCE.

### FIELD

Various example embodiments relate to the field of telecommunication and in particular, to methods, devices, apparatuses and computer readable storage medium for quality of experience (QoE) measurement collection (QME) in a radio resource control idle (RRC-IDLE) mode of a terminal device.

### BACKGROUND

The feature of QoE Measurement Collection (QME) allows the collection of QoE measurements (delay, jitter, etc.) produced by the Application Layer in user equipment (UE). This feature was specified for 3G, LTE and is introduced in new radio (NR) in Rel-17. In Rel-17, for NR, three services are relevant for the collection of QoE measurement in RRC_CONNECTED mode, but in Rel-18, the UE may need to collect and store QoE measurement in RRC_IDLE mode.

### SUMMARY

In general, example embodiments of the present disclosure provide a solution for QME in an RRC-IDLE mode of a terminal device.

In a first aspect, there is provided a first access network device. The first access network device comprises at least one processor and at least one memory storing instructions. The instructions, when executed by the at least one processor, cause the first access network device at least to: determine that a terminal device is to perform a quality of experience, QoE, measurement collection after disconnection from the first access network device; based on determining that the terminal device is to perform a QoE measurement collection after disconnection, transmit, to the terminal device, a QoE context identifier identifying QoE context information used for the QoE measurement collection; and transmit the QoE context identifier and the QoE context information to a core network device.

In a second aspect, there is provided a second access network device. The second network device comprises at least one processor and at least one memory storing instructions. The instructions, when executed by the at least one processor, cause the first access network device at least to: determine that a terminal device performing a quality of experience, QoE, measurement collection in an idle state connects to the second access network device; based on determining that the terminal device connects to the second access network device, receive, from the terminal device, a QoE context identifier identifying QoE context information used for the QoE measurement collection; transmit, to a core network device, a request for the QoE context information associated with the QoE context identifier; and receive the QoE context information from the core network device.

In a third aspect, there is provided a terminal device. The terminal device comprises at least one processor and at least one memory storing instructions. The instructions, when executed by the at least one processor, cause the terminal device at least to: receive, from a first access network device, a quality of experience, QoE, configuration for performing a QoE measurement collection in an idle state, receive, from the first access network device, a QoE context identifier identifying QoE context information used for the QoE measurement collection; store the QoE context identifier in the terminal device; disconnect from the first access network device, connect to a second access network device; and based on connecting to the second access network device, transmit the QoE context identifier to the second access network device.

In a fourth aspect, there is provided a method implemented at a first access network device. The method comprises determining that a terminal device is to perform a quality of experience, QoE, measurement collection after disconnection from the first access network device; based on determining that the terminal device is to perform a QoE measurement collection after disconnection, transmitting, to the terminal device, a QoE context identifier identifying QoE context information used for the QoE measurement collection; and transmitting the QoE context identifier and the QoE context information to a core network device.

In a fifth aspect, there is provided a method implemented at a second network access device. The method comprises determining that a terminal device performing a quality of experience, QoE, measurement collection in an idle state connects to the second access network device; based on determining that the terminal device connects to the second access network device, receiving, from the terminal device, a QoE context identifier identifying QoE context information used for the QoE measurement collection; transmitting, to a core network device, a request for the QoE context information associated with the QoE context identifier; and receiving the QoE context information from the core network device.

In a sixth aspect, there is provided a method implemented at a terminal device. The method comprises receiving, from a first access network device, a quality of experience, QoE, configuration for performing a QoE measurement collection in an idle state; receiving, from the first access network device, a QoE context identifier identifying QoE context information used for the QoE measurement collection; storing the QoE context identifier in the terminal device; disconnecting from the first access network device; connecting to a second access network device; and based on connecting to the second access network device, transmitting the QoE context identifier to the second access network device.

In a seventh aspect, there is provided a first apparatus. The first apparatus comprises means for determining that a terminal device is to perform a quality of experience, QoE, measurement collection after disconnection from the first apparatus; means for, based on determining that the terminal device is to perform a QoE measurement collection after disconnection, transmitting, to the terminal device, a QoE context identifier identifying QoE context information used for the QoE measurement collection; and means for transmitting the QoE context identifier and the QoE context information to a core network device.

In an eighth aspect, there is provided a second apparatus. The second apparatus comprises means for determining that a terminal device performing a quality of experience, QoE, measurement collection in an idle state connects to the second apparatus; means for, based on determining that the terminal device connects to the second apparatus, receiving, from the terminal device, a QoE context identifier identifying QoE context information used for the QoE measurement collection; means for transmitting, to a core network device, a request for the QoE context information associated with the QoE context identifier; and means for receiving the QoE context information from the core network device.

In a ninth aspect, there is provided a third apparatus. The third apparatus comprises means for receiving, from a first access network device, a quality of experience, QoE, configuration for performing a QoE measurement collection in an idle state; means for receiving, from the first access network device, a QoE context identifier identifying QoE context information used for the QoE measurement collection; means for storing the QoE context identifier in the third apparatus; means for disconnecting from the first access network device; means for connecting to a second access network device; and means for based on connecting to the second access network device, transmit the QoE context identifier to the second access network device.

In a tenth aspect, there is provided a computer program comprising instructions, which, when executed by a first apparatus, cause the first apparatus at least to: determine that a terminal device is to perform a quality of experience, QoE, measurement collection after disconnection from the first apparatus; based on determining that the terminal device is to perform a QoE measurement collection after disconnection, transmit, to the terminal device, a QoE context identifier identifying QoE context information used for the QoE measurement collection; and transmit the QoE context identifier and the QoE context information to a core network device.

In a eleventh aspect, there is provided a computer program comprising instructions, which, when executed by a second apparatus, cause the second apparatus at least to: determine that a terminal device performing a quality of experience, QoE, measurement collection in an idle state connects to the second apparatus; based on determining that the terminal device connects to the second apparatus, receive, from the terminal device, a QoE context identifier identifying QoE context information used for the QoE measurement collection; transmit, to a core network device, a request for the QoE context information associated with the QoE context identifier; and receive the QoE context information from the core network device.

In a twelfth aspect, there is provided a computer program comprising instructions, which, when executed by a third apparatus, cause the third apparatus at least to: receive, from a first access network device, a quality of experience, QoE, configuration for performing a QoE measurement collection in an idle state; receive, from the first access network device, a QoE context identifier identifying QoE context information used for the QoE measurement collection; store the QoE context identifier in the third apparatus; disconnect from the first access network device; connect to a second access network device; and based on connecting to the second access network device, transmit the QoE context identifier to the second access network device.

In a thirteenth aspect, there is provided a first network access device comprising: determining circuitry configured to determine that a terminal device is to perform a quality of experience, QoE, measurement collection after disconnection from the first access network device; based on determining that the terminal device is to perform a QoE measurement collection after disconnection, transmitting circuitry configured to transmit, to the terminal device, a QoE context identifier identifying QoE context information used for the QoE measurement collection; and transmitting circuitry configured to transmit the QoE context identifier and the QoE context information to a core network device.

In a fourteenth aspect, there is provided a second network access device comprising: determining circuitry configured to determine that a terminal device performing a quality of experience, QoE, measurement collection in an idle state connects to the second access network device; based on determining that the terminal device connects to the second access network device, receiving circuitry configured to receive, from the terminal device, a QoE context identifier identifying QoE context information used for the QoE measurement collection; transmitting circuitry configured to transmit, to a core network device, a request for the QoE context information associated with the QoE context identifier; and receiving circuitry configured to receive the QoE context information from the core network device.

In a fifteenth aspect, there is provided a terminal device comprising: receiving circuitry configured to receive, from a first access network device, a quality of experience, QoE, configuration for performing a QoE measurement collection in an idle state; receiving circuitry configured to receive, from the first access network device, a QoE context identifier identifying QoE context information used for the QoE measurement collection; storing circuitry configured to the QoE context identifier in the terminal device; disconnecting circuitry configured to disconnect from the first access network device; connecting circuitry configured to connect to a second access network device; and based on connecting to the second access network device, transmitting circuitry configured to transmit the QoE context identifier to the second access network device.

In a sixteenth aspect, there is provided a non-transitory computer readable medium comprising program instructions for causing an apparatus to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a flowchart illustrating an example of process for QoE according to some embodiments of the present disclosure;

FIG. 3 illustrates a flowchart illustrating a another example of process for QoE according to some embodiments of the present disclosure;

FIG. 4 illustrates a flowchart of a method implemented at a first access network device according to some embodiments of the present disclosure;

FIG. 5 illustrates a flowchart of a method implemented at a second access network device according to some other embodiments of the present disclosure;

FIG. 6 illustrates a flowchart of a method implemented at a terminal device according to some other embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” and “access network device” refer to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As stated above, the feature of QMC allows the collection of QoE measurements (delay, jitter, etc.) produced by the application layer in the terminal device and collected via the control plane of the radio interface (i.e., through RRC layer). QoE feature is specified for 3G, LTE and is introduced in NR in Rel-17. A specific signalling radio bearer (SRB), such as SRB4, is used to send the QoE measurements to the network. In Rel-17, for NR, three services are relevant for the collection of QoE measurement (Dynamic Adaptive Streaming over HTTP (DASH), Multimedia Telephony Service for IMS (MTSI), and Virtual Reality (VR)). But in Rel-18, multicast broadcast services (MBS) service will be part of the collection. With this new service, terminal device should be able to collect and store QoE measurements in RRC_IDLE and RRC_INACTIVE mode.

MBS is a new feature in 5G defined in Rel-17. MBS have been designed to allow for resource efficient transmission to multiple end users which require receiving same contents. And since broadcasting is spreading information only in downlink (DL), it can be even used in RRC idle mode, i.e., all terminal devices in the broadcast service area are authorized to receive the data. 5G-MBS has been introduced in 3GPP with Rel-17. Further standardization will be made to support new Rel-18 objectives of both radio access network (RAN) and core network (CN) aspects. Based on Rel-17 work, broadcast services can be received in all RRC states, whereas multicast can only be received in RRC connected state. However, Rel-18 has an objective to also allow terminal devices to receive multicast in RRC inactive state. The main difference between broadcast and multicast is that the terminal device joins a multicast session by non-access stratum (NAS) layer signalling, whereas network is unaware of the terminal devices receiving broadcast services.

In Rel-17, QMC mechanism for RRC connected or inactive, besides the container AppLayerMeasConfig sent to the terminal device app layer, there are some additional QMC context parameters used by a network device, such as an access network device, e.g., MCEaddress (the Address of measurement collection entity (MCE)), QoE reference identity (ID) (The ID allocated to the QoE collection job), and Areascope (the area in which the QoE measurement are collected). The terminal device is not aware of these parameters (Note: QoE reference ID and area info may be included in AppLayerMeasConfig container).

When the terminal device comes back to RRC connected from idle mode, due to new connection setup, there is no QMC context of the terminal device in the new serving network device or any previous serving network device because terminal device context is not stored in RAN when terminal device is in idle mode. Without these QMC contexts, a network device can't forward terminal device collected QoE measurement data to the corresponding MCE, and can't manage the terminal device's QoE measurement continuity, and will have no knowledge of configured RAN visible reporting. For example, the network device is supposed to forward the terminal device collected QoE measurements to the MCE but does not know the MCE address (where the data should be forwarded).

According to embodiments of the present disclosure, there is provided a solution for QoE measurement collection for RRC idle mode. When a terminal device is to be released to idle and the terminal device has QoE measurement configuration that will not be deleted in idle mode (e.g. QMC configured for MBS), the last serving network device sends a QoE context identifier (such as “QoE Info”) to the terminal device access stratum (AS) for storing. When the terminal device goes back to RRC connected mode, the terminal device communicates the QoE context identifier to the current serving network device. The serving network device may fetch the QMC context information from the core network using the QoE context identifier. Principle and embodiments of the present disclosure will be described in detail below with reference to the accompanying drawings.

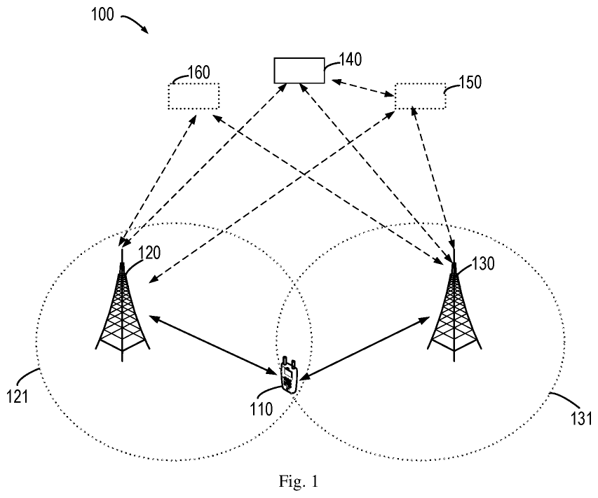

FIG. 1 illustrates a schematic diagram of an example communication network 100 in which some embodiments of the present disclosure can be implemented. As shown in FIG. 1, the communication network 100 may include a terminal device 110 and network devices 120 and 130. The network device 120 may provide a group of cells (for convenience, only one cell 121 is shown) to serve one or more terminal devices. The network device 130 may also provide a group of cells (for convenience, only one cell 131 is shown) to serve one or more terminal devices. For convenience, the term “a group of cells” may be interchangeably used with “a cell group”. In some embodiments, the terminal device 110 may be located in the cell 121 and served by the network device 120. In some embodiments, the terminal device 120 may be located in the cell 131 and served by the network device 130.

The communication network 100 may further comprise a core network device 140, for example, a core network device hosting an Access and Mobility Management Function (AMF). The communication network 100 may further comprise a measurement collection entity (MCE) 160 and an operation administration and maintenance (OAM) 150. It is to be understood that the AMF 140, the MCE 160 and the OAM 150 are merely examples, and any other suitable forms are also feasible.

In some embodiments, the terminal device 110 may perform a signaling based QoE measurement. In this case, the OAM 150 may initiate activation of a QoE measurement for a specific terminal device via a CN and a network device (e.g., the network device 120) may receive one or more QoE measurement configurations.

In some embodiments, the network device 120 may detect that the terminal device 110 may go to idle mode. Then the network device 120 may transmit a QoE context identifier to the terminal device 110 AS for storing. And when the terminal device 110 goes back to RRC connected mode, the terminal device 110 communicates the QoE context identifier to the current serving network device, such as the network device 130 or the network device 120. The network device 130 may fetch the QMC context information from the AMF 140 using the QoE context identifier. In some embodiments, the terminal device 110 and the network device 120 may communicate via a direct SRB between the terminal device 110 and the network device 120. In some embodiments, the terminal device 110 and the network device 130 may communicate via a direct SRB between the terminal device 110 and the network device 130.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the cell 101 or 102.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

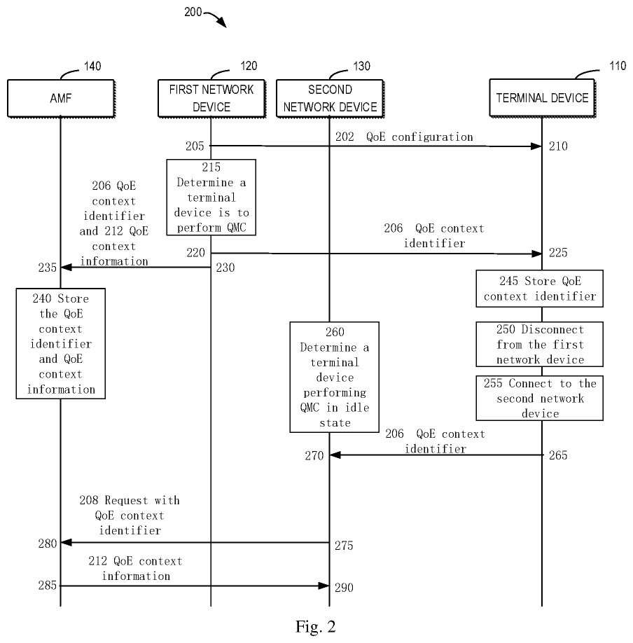

Reference is now made to FIG. 2, which shows a process 200 for QoE measurements in RRC idle mode according to some embodiments of the present disclosure. For the purpose of discussion, the process 200 will be described with reference to FIG. 1. The process 200 may involve the terminal device 110, the network device 120 acting as a first access network device, the network device 130 acting as a second access network device, and the AMF 140 as illustrated in FIG. 1. It would be appreciated that although the process 200 has been described in the communication system 100 of FIG. 1, this process may be likewise applied to other communication scenarios where different network devices are jointly deployed to provide respective serving cells. It would also be appreciated that although the QoE of the terminal device 110 is discussed, a similar process can be applied for any other terminal devices.

As shown in the process 200, the terminal device 110 may receive (210) the QoE configuration 202 from the first access network device 120. And the first access network device 120 may determine 215 that the terminal device 110 may be to perform QMC in idle mode. So when the terminal device 110 goes to idle mode, the terminal device 110 may have QoE measurement configuration that will not be deleted in idle mode. For example, the QoE measurement may be for MBS. In some embodiments, the access network device 120 may determine 215 that the terminal device 110 is to perform a QoE, measurement collection after disconnection from the first access network device 120. And based on this determination, the first access network device 120 may transmit a QoE context identifier 206 to the terminal device 110. The QoE context identifier 206 may identify QoE context information 212 which is used for the QoE measurement collection. And the first access network device 120 may transmit 230 the QoE context identifier 206 and the QoE context information 212 to the AMF 140.

As shown in the process 200, the first access network device 120 may transmit (230) to the AMF 140 the QoE context identifier 206 and the QoE context information 212. Upon receiving (235) the QoE context identifier 206 and the QoE context information 212, the AMF 140 stores (240) the QoE context identifier 206 and associated QoE context information 212. Then the access network devices 120 and 130 may retrieve the QoE context information 212 later by means of the QoE context identifier 206. The first access network device 120 may transmit 220 to the terminal device 110, the QoE context identifier 206. Upon receiving (210) the QoE context identifier 206, the terminal device 110 stores (245) the QoE context identifier 212. And then the terminal device 110 may disconnect (250) from the first access network device 120.

When the terminal device 110 goes back to connected mode, the terminal device 110 may connect (255) to the second access network device 130, and transmit (265) the QoE context identifier 206 to second access network device 130. Upon receiving (270) the QoE context identifier 206, the second access network device 130 may transmit (275) a request including the QoE context identifier 206 for the QoE context information 212 to the AMF 140. The QoE context identifier 206 is used by the first access network device 120 and by the AMF to identify the relevant QoE context information 212. Upon receiving (280) the request, the AMF 140 may transmit (285) the QoE context information 212 to the second access network device 130. So the second access network device 130 may receive (290) the QoE context information 212 from the AMF 140, and can get the MCE address in the QoE context information 212 and forward the QoE report received from the terminal device 110 and performed during the stay in idle mode to the AMF 140.

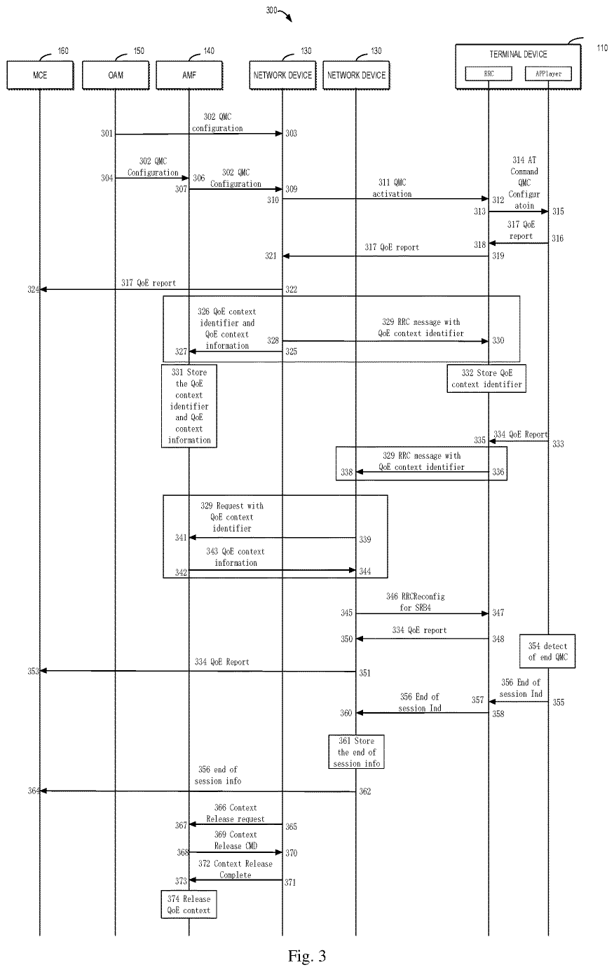

Reference is now made to FIG. 3, which shows a detail process 300 for QoE measurements in RRC idle mode according to some embodiments of the present disclosure. For the purpose of discussion, the process 300 will be described with reference to FIG. 1. The process 300 may involve the terminal device 110, the network devices 120, the network device 130, the AMF 140, the MCE 142 and the OAM 150 as illustrated in FIG. 1. It would be appreciated that although the process 300 has been described in the communication system 100 of FIG. 1, this process may be likewise applied to other communication scenarios where different network devices are jointly deployed to provide respective serving cells. It would also be appreciated that although the QoE of the terminal device 110 is discussed, a similar process can be applied for any other terminal devices.

As shown in the process 300, the OAM 150 may transmit (301) a QMC configuration 302 to the network device 120 for QoE measurement collection. Alternatively, the OAM may transmit (304) a QMC configuration 302 to the AMF 140 for QMC measurement collection. Then the AMF 140 may transmit (307) the QMC configuration 302 to the network device 120 for QMC measurement collection of the terminal device 110. Upon receiving (303) the QMC configuration from the OAM 150 or receiving (309) the QMC configuration from the AMF 140, the network device 120 may transmit (310) a QMC activation message 311 to the terminal device 110 for QMC via a RRC message. The AS of terminal device 110 (terminal device-RRC) may transmit (313) the activation command and QMC configuration 314 to the application layer of the terminal device 110 for QMC. The QMC configuration comprises the QoE configuration. And the QoE configuration is at least partly determined based on QoE context information. And the QoE context information is identified by a QoE context identifier.

When QoE measurements are available, the application layer may transmit (316) a QoE report 317 to the AS of terminal device 110. The AS of terminal device 110 then transmits (319) the report 317 to the network device 120. The network device 120 forwards (322) the report 317 to the MCE 160 based on the QoE context information.

When the terminal device 110 goes to idle mode, the terminal device 110 may have QoE measurement configuration that will not be deleted in idle mode. For example, the QoE measurements may be for MBS.

In some embodiments, to maintain the QoE context information, the network device 120 may determine that the terminal device 110 is to perform a QoE, measurement collection after disconnection from the network device 120. And based on this determination, the network device 120 may transmit a QoE context identifier to the terminal device 110. The QoE context identifier may identify QoE context information which is used for the QoE measurement collection. And the access network device 120 may transmit the QoE context identifier and the QoE context information to the AMF 140.

As shown in the process 300, the network device 120 may transmit (325), to the AMF 140, the QoE context identifier and the QoE context information 326. And the AMF 140 stores (331) the QoE context identifier and the QoE context information. Then the network devices 120 and 130 may retrieve the QoE context information later using the QoE context identifier.

In some embodiments, after the network device 120 has determined that the terminal device 110 is to disconnect from the network device 120, the QoE context identifier and the QoE context information are transmitted to the AMF 140.

In some embodiments, the QMC context information may include the full QoE configuration of the terminal device 110, the MCE address, and the RAN visible QoE (RV-QoE) configuration of the terminal device 110. And the QMC context information may contain a QoE reference ID and an AreaScope as well.

As shown in the process 300, the network device 120 may transmit (328) to the terminal device 110, an RRC message comprising the QoE context identifier 329. The RRC message may be any RRC message. For example, the RRC message is, but is not limited to, an RRCRelease message, or an RRCReconfiguration message. The terminal device 110 may stores (332) the QoE context identifier.

In some embodiments, after the network device 120 has determined that the terminal device 110 is to disconnect from the network device 120, the QoE context identifier is transmitted to the terminal device 110. Alternatively, the QoE context identifier is transmitted at an earlier point in time in order to ensure better robustness for the case of radio connection failure.

In some embodiments, the QoE context identifier may be a QoE reference ID or one ID that can be mapped to a QoE reference ID. Alternatively, there may be a container that contains the entire relevant configuration (including QMC context information). In this scenario, the network device 120 may send the container to the terminal device 110, and the terminal device 110 may return the container after re-connection to the network device 120 or connection to another network device. In this case, the network device 120 may not send the QoE context identifier and QoE context information to the AMF 140. In some embodiments, the QoE context identifier may be terminal device specific. Alternatively, several terminal devices may share the same QoE configuration and thus the same QoE context identifier.

As shown in the process 300, during the terminal device 110 stay in idle mode, the application layer of the terminal device 110 may transmit (333) QoE reports 334 to the AS of the terminal device 110. Alternatively, the application layer of the terminal device 110 may store the QoE reports in the memory of the application layer before forwarding the QoE reports to the AS of the terminal device 110 when a connection with the network is restored. When the terminal device 110 goes back to connected mode with another network device 130, the terminal device 110 may transmit (336) an RRC message to the network device 130, including the QoE context identifier. The RRC message may be any RRC message. For example, the RRC message is, but is not limited to, an RRCConnectSetupComplete message.

The network device 130 may transmit (339) a request with the QoE context identifier 329 for the QoE context information to the AMF 140. The QoE context identifier is used to identify the QMC context information. In some embodiments, the network device 130 may fetch all or part of the QMC context information from the AMF 140 using the QoE context identifier.

The AMF 140 may transmit (342) the QMC context configuration 343 to the network device 130. The network device 130 may transmit (345) RRC configuration 346 of the SRB4 for the terminal device 110 for transmitting the stored QoE Reports. The terminal device 110 may transmit (348) to the network device 130 the QoE reports 334 stored during the stay in idle mode. Based on the QMC context information received from the AMF 140, the network device 130 may forwards (351) the QoE report 334 to the MCE 160 by means of the MCEAddress, which is part of the QoE context information received from the AMF 140.

In some embodiments, the network device 130 may configure a new QMC configuration for the terminal device 110. Alternatively, the network device 130 may indicate to the terminal device 110 that the old QMC configuration may be used continually. Alternatively, the network device 130 may indicate to the terminal device 110 that the QMC configuration is to be stopped. Alternatively, the network device 130 may re-use the RAN Visible (RV)-QoE configuration that was used before idle mode of the terminal device 110.

In some scenarios, the application layer of the terminal device 110 may detect (354) the end of the logging duration, or other stop criteria is satisfied. Then the application layer of the terminal device 110 may transmit (355) the end of QMC session indication 356 to the AS layer of the terminal device 110. And the AS layer of the terminal device 110 may transmit (358) the end of QMC session indication 356 to the network device 130. The network 130 stores (361) the end of session info in the terminal device context. The network device 130 transmits (362) the end of QMC session indication 356 to the MCE 160. Then the terminal device 110 transits to RRC idle mode.

The network device 120 transmits (365) a terminal device context release request 366 to the AMF 140. And the AMF 140 transmit (368) a terminal device context release command 369 to the network device 120. The network device 120 transmits (371) the indication of terminal device context release complete message 372 to the AMF 140. The indication is about the QoE session is ended by the terminal device 110. Then the AMF 140 releases (374) the QMC context.

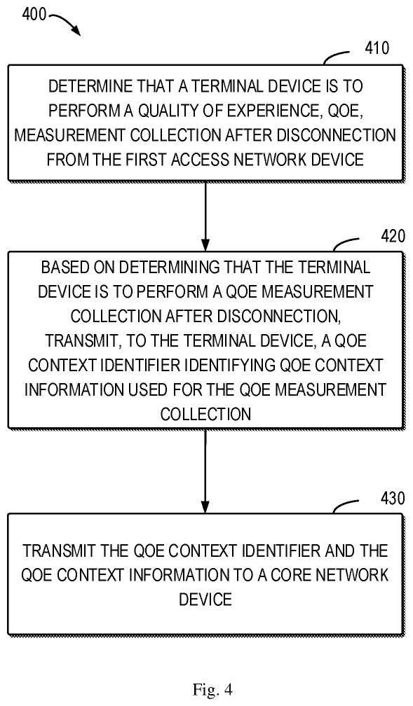

FIG. 4 shows a flowchart of an example method 400 implemented at an access network device in accordance with some embodiments of the present disclosure. For the purpose of discussion, the method 400 will be described from the perspective of the access network device 120 with reference to FIG. 1.

At block 410, the access network device 120 determines that a terminal device 110 is to perform a quality of experience, QoE, measurement collection after disconnection from the access network device 120. Based on determining that the terminal device 110 is to perform a QoE measurement collection after disconnection, at block 420, the access network device 120 transmits, to the terminal device 110, a QoE context identifier identifying QoE context information used for the QoE measurement collection. And at block 430, the access network device 120 transmits the QoE context identifier and the QoE context information to the core network device 140.

In some embodiments, the access network device 120 transmits the QoE context identifier to the terminal device 110 by determining that the terminal device 110 is to disconnect from the access network device 120, and based on determining that the terminal device 110 is to disconnect from the access network device 120, transmitting, to the terminal device 110, the QoE context identifier. In some embodiments, the QoE context identifier is transmitted via a radio resource control, RRC, connection release message.

In some embodiments, the access network device 120 transmits the QoE context identifier and the QoE context information to the core network device 140 by determining that the terminal device 110 is to disconnect from the access network device 120, and based on determining that the terminal device 110 is to disconnect from the access network device 120, transmitting, to the core network device 140, the QoE context identifier and the QoE context information.

In some embodiments, the QoE context information comprises a measurement collection entity, MCE, address to which a QoE measurement report received from the terminal device 110 is to be forwarded. In some embodiments, the access network device 120 is caused to transmit the QoE context identifier and the QoE context information to the core network device 140 by: transmitting the QoE context identifier and the QoE context information to the core network device 140 for further storage, and the QoE context information will be subsequently retrieved by the access network device 120 or by the access network device 130.

In some embodiments, the access network device 120 transmit to the terminal device 110, a QoE configuration for performing the QoE measurement collection prior to the terminal device being disconnected from the access network device 120, wherein the QoE configuration is based on the QoE context information.

In some embodiments, the QoE context identifier is specific to the terminal device 110. In some embodiments, the QoE context identifier is common to a plurality of terminal devices including the terminal device 110. In some embodiments, the core network device 140 hosts an access and mobility management function, AMF. In some embodiments, the access network device 120 receives end of session information for ending the QoE measurement collection from the terminal device 110, and store the end of session information in a context of the terminal device 110, and transmit the end of session information to the core network entity 160, for ending the QoE measurement collection.

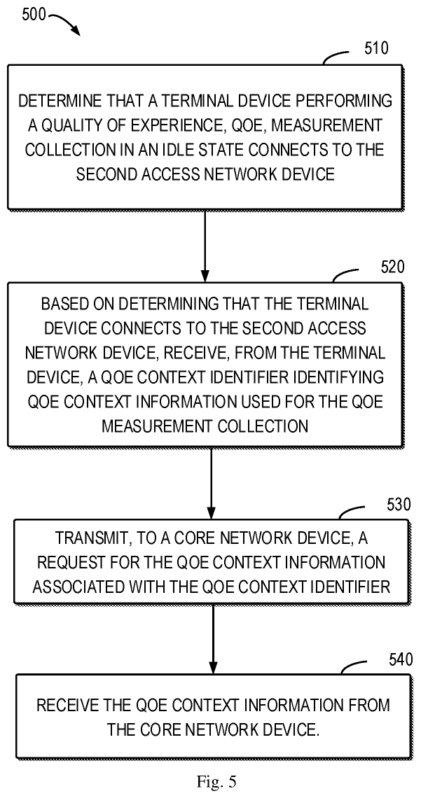

FIG. 5 shows a flowchart of an example method 500 implemented at another access network device in accordance with some embodiments of the present disclosure. For the purpose of discussion, the method 500 will be described from the perspective of the access network device 130 with reference to FIG. 1.

At block 510, the access network device 130 determines that the terminal device 110 performing a quality of experience, QoE, measurement collection in an idle state connects to the access network device 130. And based on determining that the terminal device 110 connects to the access network device 130, at block 520, the access network device 130 receives, from the terminal device 110, a QoE context identifier identifying QoE context information used for the QoE measurement collection. At block 530, the access network device 130 transmits to the core network device 140, a request for the QoE context information associated with the QoE context identifier. And at block 540, the access network device 130 receives the QoE context information from the core network device 140.

In some embodiments, the QoE context information comprises an MCE address to which a QoE measurement report received from the terminal device 110 is to be forwarded. In some embodiments, the access network device 130 receives, from the terminal device 110, a report of the QoE measurement collection, and transmits the report to a measurement collection entity, MCE, based on the received QoE context information, and more specifically based on the received MCE address. In some embodiments, the QoE context identifier is specific to the terminal device 110. In some embodiments, the QoE context identifier is common to a plurality of terminal devices including the terminal device 110. In some embodiments, the core network device 140 hosts an access and mobility management function, AMF.

In some embodiments, the access network device 130 receives end of session information for ending the QoE measurement collection from the terminal device, and stores the end of session information in a context of the terminal device, and transmits the end of session information to an MCE for ending the QoE measurement collection. In some embodiments, the QoE context identifier is received via an RRC connection setup complete message.

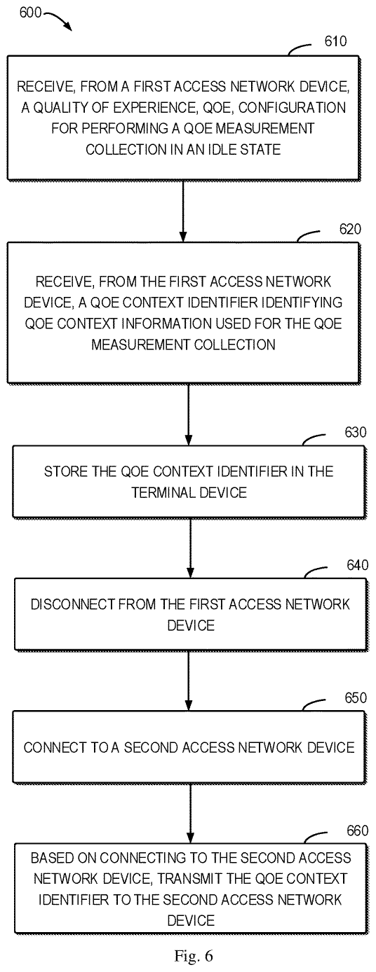

FIG. 6 shows a flowchart of an example method 600 implemented at a terminal device in accordance with some embodiments of the present disclosure. For the purpose of discussion, the method 600 will be described from the perspective of the terminal device 110 with reference to FIG. 1.

At block 610, the terminal device 110 receives from the access network device 120, a QoE configuration for performing a QoE measurement collection in an idle state. At block 620, the terminal device 110 receives from the access network device 120 a QoE context identifier identifying QoE context information used for the QoE measurement collection. At block 630, the terminal device 110 stores the QoE context identifier. At block 640, the terminal device 110 disconnects from the access network device. At block 650, the terminal device 110 connects to the access network device 130. Based on connecting to the access network device 130, at block 660, the terminal device 110 transmits the QoE context identifier to the access network device 130.

In some embodiments, the terminal device 110 receives a QoE configuration at least partly based on the QoE context information as identified by the QoE context identifier. In some embodiments, the terminal device 110 transmits, to the access network device 130, a report of the QoE measurement collection.

In some embodiments, the QoE context identifier is specific to the terminal device 110. In some embodiments, the QoE context identifier is common to a plurality of terminal devices including the terminal device 110. In some embodiments, the terminal device 110 transmits, to the access network device 130, an end of session information for ending the QoE measurement collection. In some embodiments, the access network device 120 and the access network device 130 are a same access network device.

In some embodiments, the QoE context identifier is received from the access network device 120 via an RRC connection release message. In some embodiments, the QoE context identifier is transmitted to the access network device 130 via an RRC connection setup complete message.

In some embodiments, a first apparatus capable of performing any of the method 400 (for example, the access network device 120) may comprise means for performing the respective steps of the method 400. The means may be implemented in any suitable form. For example, the means may be implemented in a circuitry or software module.

In some embodiments, the apparatus comprises means for determining that a terminal device is to perform a quality of experience, QoE, measurement collection after disconnection from the first apparatus; based on determining that the terminal device is to perform a QoE measurement collection after disconnection, means for transmitting, to the terminal device, a QoE context identifier identifying QoE context information used for the QoE measurement collection, and means for transmitting the QoE context identifier and the QoE context information to a core network device.

In some embodiments, the means for transmitting the QoE context identifier to the terminal device comprises: means for determining that the terminal device is to disconnect from the first apparatus; and means for based on determining that the terminal device is to disconnect from first apparatus, transmitting, to the terminal device, the QoE context identifier.

In some embodiments, the QoE context identifier is transmitted via a radio resource control, RRC, connection release message.

In some embodiments, the means for transmitting the QoE context identifier and the QoE context information to the core network device comprises: means for determining that the terminal device is to disconnect from the first apparatus; and based on determining that the terminal device is to disconnect from the first apparatus, mean for transmitting, to the core network device, the QoE context identifier and the QoE context information.

In some embodiments, the QoE context information comprises a measurement collection entity, MCE, address to which a QoE measurement report received from the terminal device is to be forwarded.

In some embodiments, the means for transmitting the QoE context identifier and the QoE context information to a core network device comprises: means for transmitting the QoE context identifier and the QoE context information to the core network device for further storage, wherein the QoE context information will be subsequently retrieved by the first apparatus or by another apparatus.

In some embodiments, the apparatus comprises means for transmitting, to the terminal device, a QoE configuration for performing the QoE measurement collection prior to the terminal device being disconnected from the first apparatus, wherein the QoE configuration is based on the QoE context information.

In some embodiments, the QoE context identifier is specific to the terminal device.

In some embodiments, the QoE context identifier is common to a plurality of terminal devices including the terminal device.

In some embodiments, the core network device hosts an access and mobility management function, AMF.

In some embodiments, the first apparatus comprises means for receiving end of session information for ending the QoE measurement collection from the terminal device; storing the end of session information in a context of the terminal device; and transmitting the end of session information to a core network entity, for ending the QoE measurement collection.

In some embodiments, the apparatus further comprises means for performing other steps in some embodiments of the method 400. In some embodiments, the means comprises at least one processor; and at least one memory including computer program code, the at least one memory and computer program code configured to, with the at least one processor, cause the performance of the apparatus.

In some embodiments, a second apparatus capable of performing any of the method 500 (for example, the access network device 130) may comprise means for performing the respective steps of the method 500. The means may be implemented in any suitable form. For example, the means may be implemented in a circuitry or software module.

In some embodiments, the second apparatus comprises: means for means for determining that a terminal device performing a quality of experience, QoE, measurement collection in an idle state connects to the second apparatus, based on determining that the terminal device connects to the second apparatus, means for receiving, from the terminal device, a QoE context identifier identifying QoE context information used for the QoE measurement collection; means for transmitting, to a core network device, a request for the QoE context information associated with the QoE context identifier; and means for receiving the QoE context information from the core network device.

In some embodiments, the QoE context information comprises a measurement collection entity, MCE, address to which a QoE measurement report received from the terminal device is to be forwarded.

In some embodiments, the second apparatus comprises: means for receiving, from the terminal device, a report of the QoE measurement collection; and means for transmitting the report to a measurement collection entity, MCE, based on the received QoE context information.

In some embodiments, the QoE context identifier is specific to the terminal device.

In some embodiments, the QoE context identifier is common to a plurality of terminal devices including the terminal device.

In some embodiments, the core network device hosts an access and mobility management function, AMF.

In some embodiments, the second apparatus comprises means for receiving end of session information for ending the QoE measurement collection from the terminal device; storing the end of session information in a context of the terminal device; and transmitting the end of session information to a core network entity, for ending the QoE measurement collection.

In some embodiments, the QoE context identifier is received via a radio resource control, RRC, connection setup complete message.

In some embodiments, the second apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

In some embodiments, a third apparatus capable of performing any of the method 600 (for example, the terminal device 110) may comprise means for performing the respective steps of the method 600. The means may be implemented in any suitable form. For example, the means may be implemented in a circuitry or software module.

In some embodiments, the third apparatus comprises: means for receiving from a first access network device, a quality of experience, QoE, configuration for performing a QoE measurement collection in an idle state; means for receiving, from the first access network device, a QoE context identifier identifying QoE context information used for the QoE measurement collection; means for storing the QoE context identifier in the third apparatus; means for disconnecting from the first access network device; means for connecting to a second access network device; and based on connecting to the second access network device, means for transmitting the QoE context identifier to the second access network device.

In some embodiments, the third apparatus comprises: means for receiving a QoE configuration based on the QoE context information as identified by the QoE context identifier.

In some embodiments, the third apparatus comprises: means for transmitting, to the second access network device, a report of the QoE measurement collection.

In some embodiments, the QoE context identifier is specific to the terminal device.

In some embodiments, the QoE context identifier is common to a plurality of terminal devices including the third apparatus.

In some embodiments, the third apparatus comprises: means for transmitting, to the second access network device, an end of session information for ending the QoE measurement collection.

In some embodiments, the first access network device and the second access network device are a same access network device.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

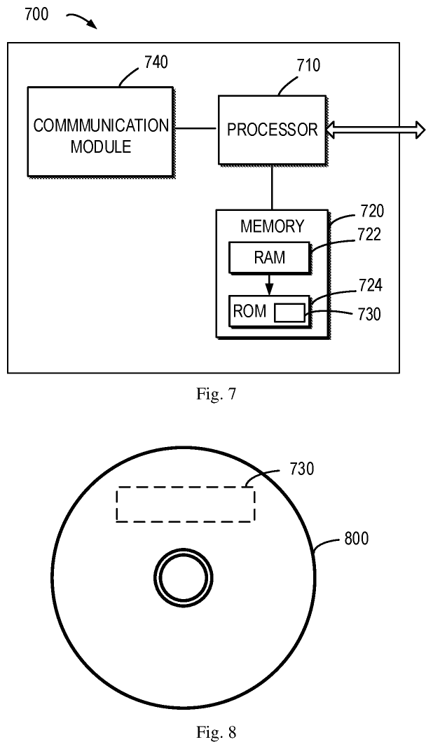

FIG. 7 is a simplified block diagram of a device 700 that is suitable for implementing embodiments of the present disclosure. The device 700 may be provided to implement the communication device, for example the terminal device 110, the network device 120, the network device 130, the AMF 140 or the MCE 142 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 1020. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 7 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first access network device comprising:
at least one processor; and
at least one memory storing instructions that, when executed by the at least one processor, cause the first access network device at least to:
determine that a terminal device is to perform a quality of experience, QoE, measurement collection after disconnection from the first access network device;
based on determining that the terminal device is to perform a QoE measurement collection after disconnection,
transmit, to the terminal device, a QoE context identifier identifying QoE context information used for the QoE measurement collection; and
transmit the QoE context identifier and the QoE context information to a core network device.

2. The first access network device of claim 1, wherein the first access network device is caused to transmit the QoE context identifier to the terminal device by:
determining that the terminal device is to disconnect from the first access network device; and
based on determining that the terminal device is to disconnect from the first access network device, transmitting, to the terminal device, the QoE context identifier.

3. The first access network device of claim 2, wherein the QoE context identifier is transmitted via a radio resource control, RRC, connection release message.

4. The first access network device of claim 2, wherein the first access network device is caused to transmit the QoE context identifier and the QoE context information to the core network device by:
determining that the terminal device is to disconnect from the first access network device; and
based on determining that the terminal device is to disconnect from the first access network device, transmitting, to the core network device, the QoE context identifier and the QoE context information.

5. The first access network device of claim 1, wherein the QoE context information comprises a measurement collection entity, MCE, address to which a QoE measurement report received from the terminal device is to be forwarded.

6. The first access network device of claim 1, wherein the first access network device is caused to transmit the QoE context identifier and the QoE context information to a core network device by:
transmitting the QoE context identifier and the QoE context information to the core network device for further storage, wherein the QoE context information will be subsequently retrieved by the first access network device or by another access network device.

7. The first access network device of claim 1, wherein the first access network device is further caused to:
transmit, to the terminal device, a QoE configuration for performing the QoE measurement collection prior to the terminal device being disconnected from the first access network device, wherein the QoE configuration is at least partly based on the QoE context information.

8. The first access network device of claim 1, wherein the QoE context identifier is specific to the terminal device.

9. The first access network device of claim 1, wherein the QoE context identifier is common to a plurality of terminal devices including the terminal device.

10. The first access network device of claim 1, wherein the core network device hosts an access and mobility management function, AMF.

11. The first access network device of claim 1, wherein the first access network device is further caused to:
receive end of session information for ending the QoE measurement collection from the terminal device;
store the end of session information in a context of the terminal device; and
transmit the end of session information to a core network entity, for ending the QoE measurement collection.

12. A second access network device comprising:
at least one processor; and
at least one memory storing instructions that, when executed by the at least one processor, cause the second access network device at least to:
determine that a terminal device performing a quality of experience, QoE, measurement collection in an idle state connects to the second access network device;
based on determining that the terminal device connects to the second access network device, receive, from the terminal device, a QoE context identifier identifying QoE context information used for the QoE measurement collection;
transmit, to a core network device, a request for the QoE context information associated with the QoE context identifier; and
receive the QoE context information from the core network device.

13. The second access network device of claim 12, wherein the QoE context information comprises a measurement collection entity, MCE, address to which a QoE measurement report received from the terminal device is to be forwarded.

14. The second access network device of claim 12, wherein the second access network device is further caused to:
receive, from the terminal device, a report of the QoE measurement collection; and
transmit the report to a measurement collection entity, MCE, based on the received QoE context information.

15. The second access network device of claim 12, wherein the QoE context identifier is specific to the terminal device.

16. The second access network device of claim 12, wherein the QoE context identifier is common to a plurality of terminal devices including the terminal device.

17. The second access network device of claim 12, wherein the core network device hosts an access and mobility management function, AMF.

18. The second access network device of claim 12, wherein the second access network device is further caused to:
receive end of session information for ending the QoE measurement collection from the terminal device;
store the end of session information in a context of the terminal device; and
transmit the end of session information to a measurement collection entity, MCE, for ending the QoE measurement collection.

19. The second access network device of claim 12, wherein the QoE context identifier is received via a radio resource control, RRC, connection setup complete message.

20. A terminal device comprising:
at least one processor; and
at least one memory storing instructions that, when executed by the at least one processor, cause the terminal device at least to:
receive, from a first access network device, a quality of experience, QoE, configuration for performing a QoE measurement collection in an idle state;
receive, from the first access network device, a QoE context identifier identifying QoE context information used for the QoE measurement collection;
store the QoE context identifier in the terminal device;
disconnect from the first access network device;
connect to a second access network device; and
based on connecting to the second access network device, transmit the QoE context identifier to the second access network device.

21. The terminal device of claim 20, wherein the terminal device is further caused to:
receive a QoE configuration at least partly based on the QoE context information as identified by the QoE context identifier.

22. The terminal device of claim 20, wherein the terminal device is further caused to:
transmit, to the second access network device, a report of the QoE measurement collection.

23. The terminal device of any of claim 20, wherein the QoE context identifier is specific to the terminal device.

24. The terminal device of claim 20, wherein the QoE context identifier is common to a plurality of terminal devices including the terminal device.

25. The terminal device of claim 20, wherein the terminal device is further caused to:
transmit, to the second access network device, an end of session information for ending the QoE measurement collection.

26. The terminal device of claim 20, wherein the first access network device and the second access network device are a same access network device.

27. The terminal device of claim 20, wherein the QoE context identifier is received from the first access network device via a radio resource control, RRC, connection release message.

28. The terminal device of claim 20, wherein the QoE context identifier is transmitted to the second access network device via an RRC connection setup complete message.

29. A method comprising:
determining, at a first access network device, that a terminal device is to perform a quality of experience, QoE, measurement collection after disconnection from the first access network device;
based on determining that the terminal device is to perform a QoE measurement collection after disconnection,
transmitting, to the terminal device, a QoE context identifier identifying QoE context information used for the QoE measurement collection; and transmitting the QoE context identifier and the QoE context information to a core network device.

30. A method comprising:
determining, at a second access network device, that a terminal device performing a quality of experience, QoE, measurement collection in an idle state connects to the second access network device;
based on determining that the terminal device connects to the second access network device, receiving, from the terminal device, a QoE context identifier identifying QoE context information used for the QoE measurement collection;
transmitting, to a core network device, a request for the QoE context information associated with the QoE context identifier; and
receiving the QoE context information from the core network device.

31. A method comprising:
receiving, at a terminal device, from a first access network device, a quality of experience, QoE, configuration for performing a QoE measurement collection in an idle state;
receiving, from the first access network device, a QoE context identifier identifying QoE context information used for the QoE measurement collection;
storing the QoE context identifier in the terminal device;
disconnecting from the first access network device;
connecting to a second access network device; and
based on connecting to the second access network device, transmitting the QoE context identifier to the second access network device.

32-35. (canceled)
